(19) United States
(12) Patent Application Publication
(10) Pub. No.: US 2019/0114532 A1
(43) Pub. Date: Apr. 18, 2019

(54) APPARATUS AND METHOD FOR CONVOLUTION OPERATION OF CONVOLUTION NEURAL NETWORK

(71) Applicant: AJOU UNIVERSITY INDUSTRY-ACADEMIC COOPERATION FOUNDATION, Suwon-si (KR)

(72) Inventors: Myung Hoon SUNWOO, Seoul (KR); Young Ho KIM, Anyang-si (KR)

(73) Assignee: AJOU UNIVERSITY INDUSTRY-ACADEMIC COOPERATION FOUNDATION, Suwon-si (KR)

(21) Appl. No.: 16/059,695

(22) Filed: Aug. 9, 2018

(30) Foreign Application Priority Data
Oct. 13, 2017 (KR) 10-2017-0133525

(51) Int. Cl. G06N 3/04; G06F 17/15; G06T 7/11

(52) U.S. Cl. CPC G06N 3/0481; G06T 2207/20021; G06T 7/11; G06F 17/15

(57) ABSTRACT

Disclosed are an apparatus and a method for a convolution operation of a convolution neural network. An apparatus for a convolution operation of a convolution neural network according to an exemplary embodiment of the present disclosure includes: an operation control unit that determines whether or not to perform the convolution operation based on the number of ‘0’ in a partial region of an input feature map; and an operation unit that performs the convolution operation of the partial region according to the determination of the operation control unit.

### CROSS-REFERENCE TO RELATED APPLICATIONS

This application claims the priority of Korean Patent Application No. 10-2017-0133525 filed on Oct. 13, 2017, in the Korean Intellectual Property Office, the disclosure of which is incorporated herein by reference.

### BACKGROUND

### Field

The present disclosure relates to an apparatus and a method for a convolution operation of a convolution neural network. More particularly, the present disclosure relates to an apparatus and a method for a convolution operation of a convolution neural network which skips a convolution operation based on the number of ‘0’ in a partial region of a feature map.

### Description of the Related Art

A convolution neural network (CNN, referred to as “CNN”), a core calculation model of deep learning, is a kind of artificial neural network in which each neuron has a characteristic similar to a response characteristic of an overlapping region in a human visual neural system.

The CNN has the advantage of recognizing images and voices having complex patterns with a high recognition rate as the number of layers increases. Accordingly, the image and voice recognition rates, which have remained stagnant for a long time, have dramatically increased recently by a CNN technology, and CNN systems are topping records in various image recognition benchmarking tests such as ImageNet. As a result, the CNN is attracting attention in various machine learning fields such as image recognition, speech recognition, and language translation.

In addition, as compared with a conventional neural network model such as multi-layered perceptron, the CNN has an advantage of being implemented with a limited memory capacity because a separate feature extraction process is not required and the amount of data required for the parameters is small.

Therefore, the CNN is suitable for processing images that are difficult to handle by general neural networks among the deep learning algorithms. In the general neural network, it is assumed that the input image is 32×32, and when the image is a color channel, weights of 32×32×3=3072 are needed. On the other hand, the CNN reduces the number of weights by using the feature that the input is constituted by images. The CNN extracts the feature of the image by repetitively applying a filter, a mask, or a kernel (weight) having a certain size to the input image. A feature map is generated by using a plurality of such filters, and the feature map is used to create an image in which a unique feature is highlighted in the input image. Here, an operation of repeatedly applying the filters to the image to extract the feature of the image is called a convolution operation. The convolution operation is a multiplication and accumulation (MAC) operation that multiplies each weight of the filter by a pixel while sliding in the image and accumulating the weights and has a large calculation amount. The convolution operation of the CNN in deep learning for analyzing the image is the most important core in deep learning and occupies most of the neural network operations.

However, the conventional convolution operation has a disadvantage that as the size of the image increases and the depth of the neural network deepens in the deep learning, the amount of computation increases.

Also, as the amount of convolution operation increases, power consumption increases, and thus there is a problem in that it is difficult to perform real-time image processing and efficient power management of the system.

In this regard, Korean Patent Publication No. 10-2017-0099848, entitled “storage device and method for performing convolution operations” is present.

### SUMMARY

An object to be achieved by the present disclosure is to provide an apparatus and a method for a convolution operation of a convolution neural network capable of reducing the amount of convolution operation while maintaining the performance of the convolution neural network.

The technical objects of the present disclosure are not restricted to the aforementioned technical objects, and other objects of the present disclosure which are not mentioned will become more apparent to one of ordinary skill in the art to which the present disclosure pertains by referencing the detailed description of the present disclosure given below.

According to an aspect of the present disclosure, there is provided an apparatus for a convolution operation of a convolution neural network including: an operation control unit that determines whether or not to perform the convolution operation based on the number of ‘0’ in a partial region of an input feature map; and an operation unit that performs the convolution operation of the partial region according to the determination of the operation control unit.

Preferably, the operation control unit may retrieve ‘0’ in the partial region and skips the convolution operation if the number of ‘0’ is equal to or greater than a predetermined threshold to output ‘0’ and provide the partial region to the operation unit when the number of ‘0’ is not equal to or greater than the threshold.

Preferably, the apparatus for a convolution operation of a convolution neural network may further include a threshold setting unit that sets a threshold based on at least one of a size of the mask (or the filter), a stride, and a position of the image.

Preferably, the threshold setting unit may decrease the threshold to less than a reference threshold when the size of the mask is equal to or greater than a reference size and increase the threshold to the reference threshold or more when the size of the mask is not equal to or greater than the reference size.

Preferably, the threshold setting unit may increase the threshold to a reference threshold or more when the stride is equal to or greater than a reference stride and decrease the threshold to less than the reference threshold when the stride is not equal to or greater than the reference stride.

Preferably, the threshold setting unit may increase the threshold toward a central portion from an edge of the image.

According to another aspect of the present disclosure, there is provided a method for a convolution operation of a convolution neural network which is performed by an apparatus for the convolution operation, the method including: determining whether or not to perform the convolution operation based on the number of ‘0’ in a partial region of an input feature map; and performing the convolution operation of the partial region when determining the performing of the convolution operation.

Preferably, in the determining the performing of the convolution operation, ‘0’ may be retrieved in the partial region and the convolution operation may be skipped if the number of ‘0’ retrieved is equal to or greater than a predetermined threshold to output ‘0’.

Preferably, the threshold may be a value set based on at least one of a size of the mask (or the filter), a stride, and a position of the image.

Preferably, the threshold may be less than a reference threshold when the size of the mask is equal to or greater than a reference size, and the threshold may be the reference threshold or more when the size of the mask is not equal to or greater than the reference size.

Preferably, the threshold may be a reference threshold or more when the stride is equal to or greater than a reference stride and the threshold may be less than the reference threshold when the stride is not equal to or greater than the reference stride.

Preferably, the threshold setting unit may increase the threshold toward a central portion from an edge of the image.

The effects according to the present disclosure are as follows.

According to the apparatus and the method for the convolution operation provided in the present disclosure, it is possible to reduce a convolution operation occupying most of the convolution neural network to increase an inference speed in the deep learning.

In addition, since the amount of convolution operation may be reduced, it is possible to reduce the power consumption and to efficiently use the power for a device with limited power.

The effects of the present disclosure are not limited to the aforementioned effects, and other objects, which are not mentioned above, will be more apparently understood to one of ordinary skill in the art from the following disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram for describing a convolution neural network structure;

FIG. 2 is a diagram illustrating an apparatus for a convolution operation of a convolution neural network according to an exemplary embodiment of the present disclosure;

FIG. 3 is a diagram for describing a sequence of a partial region for performing the convolution operation according to the exemplary embodiment of the present disclosure;

FIG. 4 is a diagram for describing a method of setting a threshold depending on the size of a mask according to the exemplary embodiment of the present disclosure;

FIG. 5 is a diagram for describing a method of setting a threshold depending on a stride according to the exemplary embodiment of the present disclosure;

FIG. 6 is a diagram for describing a method of setting a threshold depending on a position of an image according to the exemplary embodiment of the present disclosure; and

FIG. 7 is a flowchart illustrating a method for a convolution operation of a convolution neural network according to an exemplary embodiment of the present disclosure.

### DETAILED DESCRIPTION OF THE PREFERRED EMBODIMENT

The present disclosure may have various modifications and various exemplary embodiments and specific exemplary embodiments will be described in detail in the detailed description. However, this does not limit the present disclosure to specific exemplary embodiments, and it should be understood that the present disclosure covers all the modifications, equivalents, and replacements included within the idea and technical scope of the present disclosure. Like reference numerals generally denote like elements throughout the present specification.

Terms, such as first, second, A, B, and the like may be used to describe various components and the components should not be limited by the terms. The terms are used only to discriminate one constituent element from another component. For example, a first component may be referred to as a second component, and similarly, the second component may be referred to as the first component without departing from the scope of the present disclosure. A term ‘and/or’ includes a combination of a plurality of associated disclosed items or any item of the plurality of associated disclosed items.

It should be understood that, when it is described that a component is “connected to” or “accesses” another component, the component may be directly connected to or access the other component or a third component may be present therebetween. In contrast, it should be understood that, when it is described that an element is “directly connected to” or “directly access” another element, it is understood that no element is present between the element and another element.

Terms used in the present application are used only to describe specific embodiments, and are not intended to limit the present disclosure. Singular expressions used herein include plurals expressions unless they have definitely opposite meanings. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If it is not contrarily defined, all terms used herein including technological or scientific terms have the same meanings as those generally understood by a person with ordinary skill in the art. Terms defined in generally used dictionary shall be construed that they have meanings matching those in the context of a related art, and shall not be construed in ideal or excessively formal meanings unless they are clearly defined in the present application.

In this specification, although a mask and a filter are used in combination, the mask and the filter may have the same meaning.

Hereinafter, preferred exemplary embodiments of the present disclosure will be described in detail with reference to the accompanying drawings.

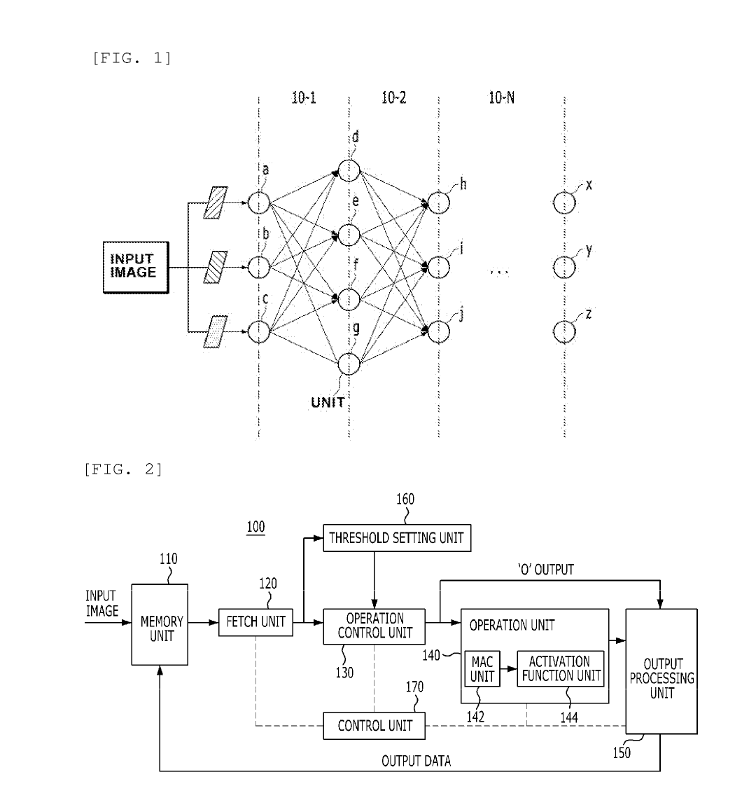

FIG. 1 is a diagram for describing a convolution neural network structure.

Referring to FIG. 1, a convolution neural network for recognizing an image using a pre-learned parameter includes a plurality of convolution layers 10-1, 10-2, . . . , and 10-N. Each of the convolution layers 10-1, 10-2, . . . , and 10-N includes a plurality of units a, b, c, . . . , x, y, and z.

Each of the units a, b, c, . . . , x, y, and z represents a feature of the input image using a two-dimensional matrix. Each of the units a, b, c, . . . , x, y, and z is used as an output unit of one convolution layer and as an input unit of the next convolution layer. For example, the units d, e, f, and g may be used as an output unit of the convolution layer 10-1 and an input unit of the convolution layer 10-2. When each of the units a, b, c, . . . , x, y, and z is used as an input unit of one convolution layer, the unit is also referred to as a channel, and when each of the units a, b, c, . . . , x, y, and z is used as an output unit of one convolution layer, the unit is also referred to as a feature map.

The input units a, b, and c of the first convolution layer 10-1 represent the image to be recognized, and generally, the first convolution layer 10-1 includes three input units a, b, and c representing red, green, and blue components of the input image, respectively.

In each of the convolution layers 10-1, 10-2, . . . , and 10-N, each input unit is fully connected with all the output units by the convolution function. For example, in the convolution layer 10-1, each of the input units a, b, and c is connected to all of the output units e, f, g, and h of the convolution layer 10-1 by the convolution function. Here, the convolution function is a function of extracting the feature of the image by applying a filter having a size of n×n to the input image.

Specifically, the convolution function is a function of applying the convolution operation to the input unit and calculating an output unit by applying a non-linear function to the input unit subjected to the convolution operation. Here, the convolution operation means extracting all partial regions having a size of n×n available in the entire regions of the input unit, and then multiplying and then summing each unit element of the filter uniquely designated between the input unit and the output unit and each value of the partial region having the size of n×n, respectively (that is, the sum of internal products between the filter and the partial region). Here, the non-linear function means, for example, a sigmoid function, a rectified linear unit (ReLU), or the like. The partial region is also referred to as a local receptive field, and the filter is constituted by n×n parameters corresponding to the size of the local receptive field and is also referred to as a kernel or mask. One kernel is commonly applied to all partial regions of an input unit (that is, channel).

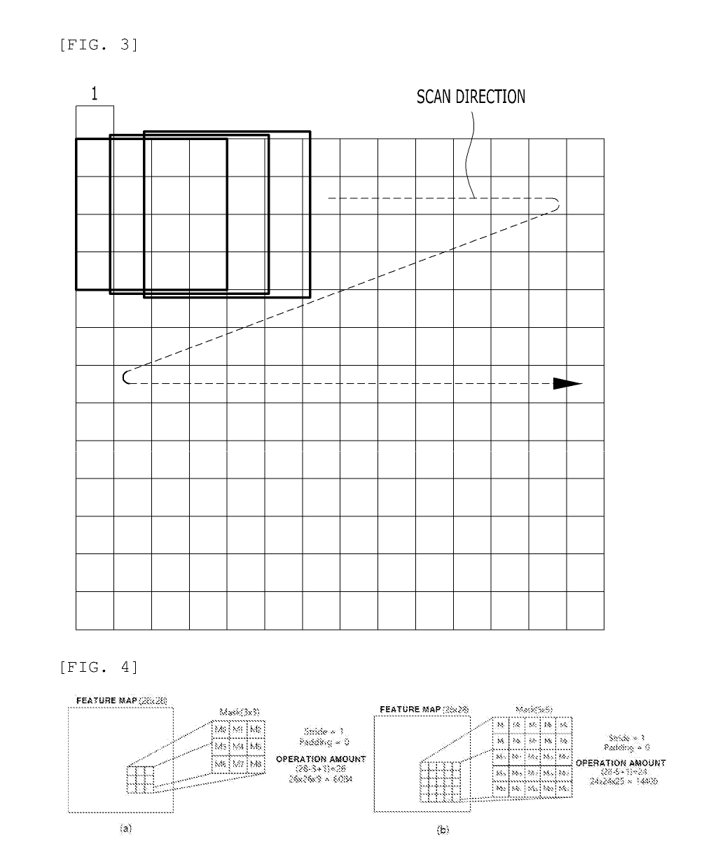

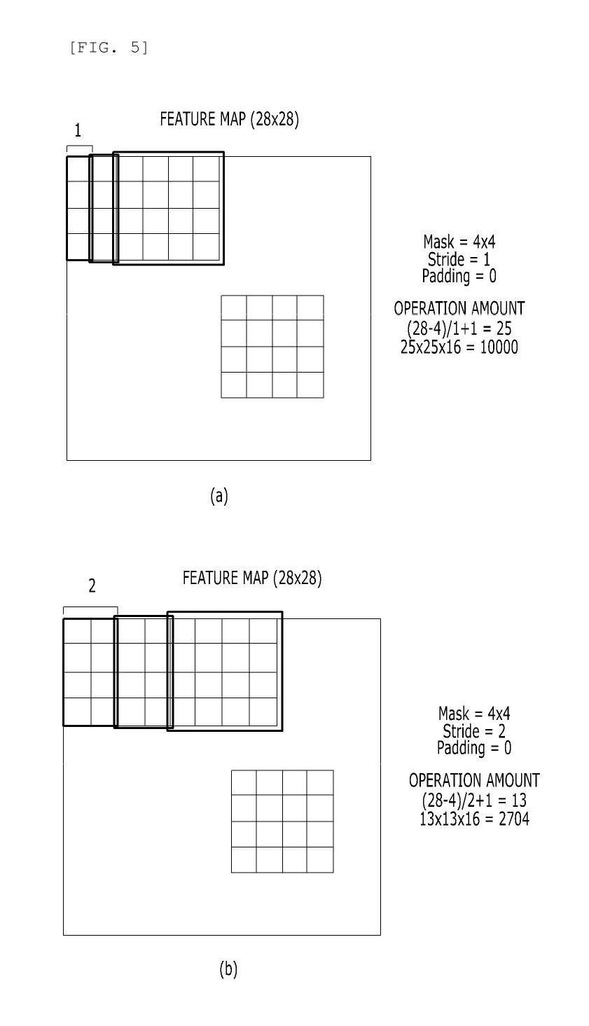

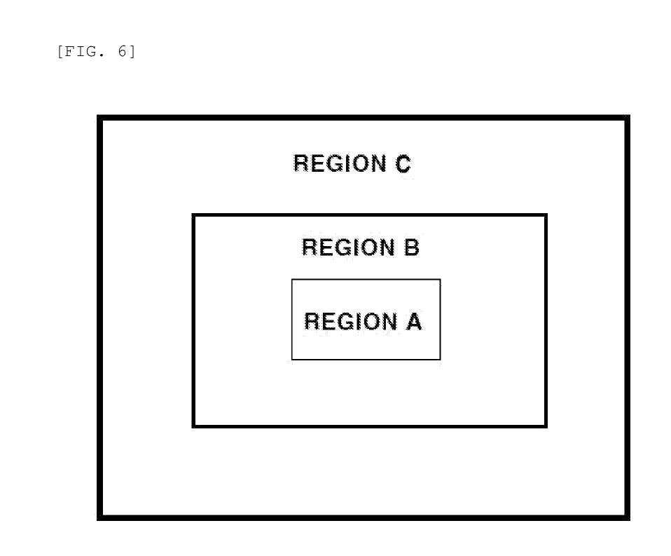

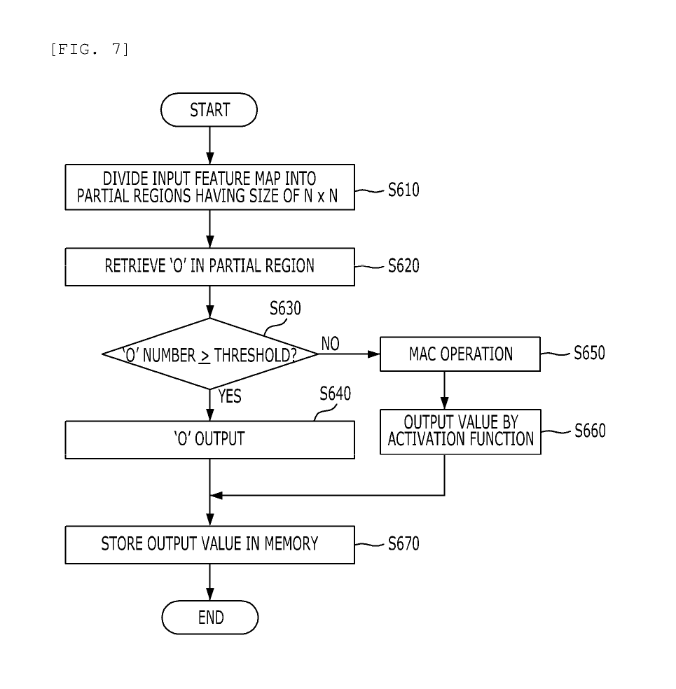

FIG. 2 is a diagram illustrating an apparatus for a convolution operation of a convolution neural network according to an exemplary embodiment of the present disclosure, FIG. 3 is a diagram for describing a sequence of a partial region for performing the convolution operation according to the exemplary embodiment of the present disclosure, FIG. 4 is a diagram for describing a method of setting a threshold depending on the size of a mask according to the exemplary embodiment of the present disclosure, FIG. 5 is a diagram for describing a method of setting a threshold depending on a stride according to the exemplary embodiment of the present disclosure, and FIG. 6 is a diagram for describing a method of setting a threshold depending on a position of an image according to the exemplary embodiment of the present disclosure.

Referring to FIG. 2, an apparatus 100 for a convolution operation of a convolution neural network according to an exemplary embodiment of the present disclosure includes a memory unit 110, a fetch unit 120, an operation control unit 130, an operation unit 140, an output processing unit 150, and a control unit 170.

The memory unit 110 receives an image (that is, image input data) from the outside and receives output data (that is, operation result) of the output processing unit 150. The memory unit 110 provides sequentially data (that is, data corresponding to a current layer) to be current convolution-operated (that is, data corresponding to the current layer) among the input (that is, stored) data to the fetch unit 120.

The fetch unit 120 retrieves an input feature map 160 from a memory 145 under a control of the control unit 170 to provide the retrieved input feature map to the operation control unit 130 and retrieves the weight to the operation unit 140.

The fetch unit 120 converts the feature map input from the memory unit 110 into a partial area of a size of n×n and provides the feature map to the operation control unit 130. Here, the partial region may be a receptive field (receptive region), and may be determined depending on the size of the filter (mask or kernel). For example, if the input image is 32×32 and the size of the filter is 5×5, the receptive field may be 5×5. That is, the receptive field is the same as the size of the filter.

As illustrated in FIG. 3, the fetch unit 120 scans and extracts a certain n×n partial region from the first column of the first row of the feature map in the column priority (or row priority), and provides the extracted partial region to the operation control unit 130.

Further, the fetch unit 120 is provided with a buffer so that the input feature map fetched from the memory unit 110 is stored in the buffer, and as a result, continuously provides a large amount of data required by the operation unit 140 while accessing the memory unit 110 at a relatively small number of times, thereby maximizing the efficiency of the apparatus 100 for the convolution operation of the convolution neural network.

The fetching unit 120 described above may solve a problem that may occur when the operation unit 140 directly receives the partial region having the size of n×n of the feature map from the memory unit 110, that is, a problem that a large number of memory accesses are required when the operation unit 140 directly receives the partial region of the feature map from the memory unit 110, and thus the efficiency of the apparatus 100 for the convolution operation of the convolution neural network is lowered. That is, the fetch unit 120 sequentially receives the input feature map from the memory unit 110 and converts the sequentially received feature map into the partial regions of the size of n×n to provide the converted feature map to the operation control unit 130, thereby solving the problem that the efficiency of the apparatus 100 for the convolution operation of the convolution neural network is lowered.

The operation control unit 130 determines whether or not to perform the convolution operation based on the number of ‘0’ in the partial region of the input feature map. That is, the operation control unit 130 retrieves ‘0’ in the partial region of the feature map and skips the convolution operation if the number of ‘0’ is equal to or greater than a predetermined threshold to output ‘0’ as the output data for the partial region. At this time, the operation control unit 130 may not provide the partial region to the operation unit 140 to skip the convolution operation. If the number of ‘0’ in the partial region is not equal to or greater than the threshold, the operation control unit 130 provides the partial region to the operation unit 140 to perform the convolution operation. Here, the threshold may be a value set based on the size of the mask (filter), the stride, the position of the image, and the like. A detailed description of the method of setting the threshold will be described below.

For example, the operation control unit 130 skips the convolution operation of the portion where the current filter slides and outputs ‘0’ when the number of ‘0’ is 70 to 100% of the filter size, and performs the convolution operation when the number of ‘0’ is 0 to 70% of the size of the filter.

On the other hand, the convolution neural network convolutes an N×N image and an M×M filter (mask) to perform multiplication and addition operations of M2×N2. That is, the convolution operation is performed using an input image and a weight of the filter, features are extracted from the image by output values obtained by using convolution operation result values as an input of an activation function, and the extracted features become a feature map. In addition, the convolution neural network learns the weights (values) of the filters through a learning process, and the weights (values) of the learned filters are subjected to the convolution operation with the image, and the generated feature map has a higher rate of having ‘0’ value by the activation function ReLu. In addition, since the features extracted using the weights learned in the convolution neural network are only extracted from a specific portion of the image, the value of the feature map may have a high rate of ‘0’. In the convolution operation by the filter, if the value of the feature map is ‘0’, the convolution operation is a multiplication operation, so there is no need to perform the convolution operation. Therefore, when the filter slides in the feature map, it is possible to reduce an unnecessary operation when skipping the convolution operation by first determining the number of ‘0’ in the partial region of the feature map and efficiently use power because there is no need to call the weight of the filter for operation.

As described above, the feature map of the image has a value of ‘0’ except for the portion representing the feature, and when the feature map has a value of ‘0’, the convolution operation is unnecessary. In particular, as the layer becomes deeper in the convolution neural network, many feature maps are generated, and if the value of ‘0’ is determined in the feature map, the convolution operation may be skipped adaptively.

Accordingly, the operation control unit 130 may determine the number of ‘0’ in the partial region of the feature map and determine whether to skip the convolution operation depending on the number of ‘0’.

The operation unit 140 performs the convolution operation of the partial region according to the determination of the operation control unit 130.

The operation unit 140 performs the convolution operation using the partial region of the size of n×n and the mask (filter) of the size of n×n corresponding thereof, and transmits the convolution operation result to the output processing unit 150.

The operation unit 140 includes a multiplication and accumulation (MAC) unit 142 for multiplying each value of the partial region with a corresponding weight value of the mask and then summing the values, and an activation function unit 144 for outputting the data by setting the output result of the MAC unit 142 as the input of the activation function.

The activation function unit 144 may receive a convolution operation result from the MAC unit 142 and apply an activation function to the result of the convolution operation. Here, the activation function may include, for example, sigmoid, a rectified linear unit (ReLu), and the like. Since the sigmoid is a function to have a value between 0 and 1, the result of multiplying a differential value becomes closer to 0 as the number of hidden layers increases, so that the sigmoid can not be transferred to an initial model. The ReLU solves this problem, and the ReLU is a function that outputs ‘0’ if the input value is less than 0, or continuously increases in proportion to the value if not. Therefore, the ReLU may be used as an activation function in the present disclosure.

The output processing unit 150 stores the output data (that is, ‘0’) output from the operation control unit 130 and the output data output from the operation unit 140 in the memory unit 110.

In addition, the output processing unit 150 stores a feature map in the memory unit 110 for using in processing subsequent or other layers of the convolution neural network. The stored feature map may be used as an input mask in the subsequent layer processing of the convolution neural network.

Through the aforementioned description, the apparatus 100 for the convolution operation of the convolution neural network may have a feedback structure in which the data stored in the memory unit 110 is convolution-operated in the operation unit 140 to be stored in the memory unit 110 again.

Meanwhile, according to the exemplary embodiment of the present disclosure, the apparatus for the convolution operation of the convolution neural network may further include a threshold setting unit 160 that sets a threshold based on at least one of a size of the mask (filter), a stride, and a position of the image. Here, the threshold is the number of ‘0’ for skipping the convolution operation, and may vary depending on the size of the mask (filter) used, the stride, the size of the image, the convolution neural network, and the like.

The threshold setting unit 160 may decrease the threshold when the size of the mask is equal to or greater than a predetermined reference size and increase the threshold when the size is not greater than the reference size. Here, the reference size may be a predetermined value as, for example, 70% of the mask size.

Since a portion of the image is much read and thus the features are extracted well, the larger the mask, the greater the accuracy. However, as the size of the mask increases, the amount of convolution operation increases, so that the operation time increases and the hardware resources become large. Accordingly, when the size of the mask is large, even if the threshold for skipping the convolution operation is lowered, it is possible to obtain a gain by using the operation speed and the hardware resources rather than the accuracy loss. On the contrary, when the size of the mask is small, there is a risk that the accuracy loss may increase if the threshold for skipping the convolution operation is lowered.

For example, referring to FIG. 4, the operation amount depending on the size of the mask will be described. Here, it is assumed that the feature map is 28×28 and the stride is equal to 1. (a) shows a case where a 3×3 mask is used, and the operation amount may be ‘6084’. (b) shows a case where a 5×5 mask is used, and the operation amount may be ‘14400’. As a result, it can be seen that the amount of convolution operation increases as the size of the convolution mask increases. Accordingly, (a) needs to be set to a higher threshold than (b).

Accordingly, the threshold setting unit 160 may decrease the threshold to less than a predetermined reference threshold when the size of the mask (or filter) is equal to or greater than the predetermined reference size, and increase the threshold to the reference threshold value or more when the size is not equal to or greater than the reference size. For example, a case where the reference size of the mask is 4×4 and the reference threshold is set to 80% (12) of the reference size will be described. In this case, if the partial region of the feature map is 6×6, the threshold value may be set to 10 less than 12. In addition, if the partial region of the feature map is 3×3, the threshold may be set to 14 less than 12.

Also, the threshold setting unit 160 may increase the threshold as the stride becomes larger. Here, the stride refers to an interval at which the mask slides. As the stride becomes larger, the image may be roughly swept, and since the image is roughly swept, the feature of the image is not properly extracted and thus, the accuracy may be lowered.

For example, referring to FIG. 5, the operation amount depending on the stride will be described. Here, it is assumed that the feature map is 28×28 and a 4×4 mask is used. (a) shows a case where a stride is ‘1’, and the operation amount may be ‘10000’. (b) shows a case where a stride is ‘2’, and the operation amount may be ‘2704’. As a result, it can be seen that the larger the stride, the smaller the operation amount, but the lower the accuracy. Accordingly, (b) needs to be set to a higher threshold than (a), so that the loss of accuracy may be prevented.

The threshold setting unit 160 may increase the threshold to a predetermined threshold value or more when the stride is equal to or greater than a predetermined reference stride and decrease the threshold to less than the reference threshold value when the stride is not equal to or greater than the reference stride.

For example, when the reference stride is set to ‘1’ and the reference threshold is set to ‘6’, if the stride increases to 2, 3, or the like, the threshold may increase to ‘7’, ‘8’, and the like.

Also, the threshold setting unit 160 may increase the threshold toward the central portion from the edge of the image. Since types of images are various, it is difficult to specify the threshold as the type of image, but generally, main feature points of the image are near the center of the image. Accordingly, by increasing the threshold from the edge to the center, it is possible to obtain a gain in the operation amount and the speed while reducing the loss of the accuracy.

For example, in the image illustrated in FIG. 6, if the threshold of a region A is ‘10’, a region B is ‘8’, and a region C is ‘6’, and the threshold may be lowered toward the outside from the center of the image.

The control unit 170 may control the operations of the various components of the apparatus 100 for the convolution operation.

The apparatus 100 for the convolution operation configured above may perform the convolution operation while sliding the mask (filter) sequentially in the direction illustrated in FIG. 3 up to the last partial region for the current feature map of the current layer. In FIG. 3, the case where the stride is ‘1’ is exemplified, but the stride may be set to various values.

According to the exemplary embodiment of the present disclosure, at least some of the memory unit 110, the fetch unit 120, the operation control unit 130, the operation unit 140, and the output processing unit 150 may be program modules that communicate with external terminal devices, external servers, and the like. These program modules may be included in the apparatus 100 for the convolution operation as an operating system, an application program module, and other program modules, and may be physically stored on various known memory devices. These program modules may also be stored in a remote memory device capable of communicating with the apparatus 100 for the convolution operation. Meanwhile, these program modules encompass routines, subroutines, programs, objects, components, data structures, and the like that perform the specified operations described above or implement specific abstract data types according to the present disclosure, but are not limited thereto.

FIG. 7 is a flowchart illustrating a method for a convolution operation of a convolution neural network according to an exemplary embodiment of the present disclosure.

Referring to FIG. 7, an apparatus for a convolution operation divides an input feature map into partial regions having a size of n×n (S610), retrieves ‘0’ in the partial region of the input feature map (S610), and determines whether the number of ‘0’ is equal to or greater than a predetermined threshold (S620). Here, the threshold may be a value set based on the size of the mask (filter), the stride, the position of the image, and the like.

As the determining result of step S620, when the number of ‘0’ s is equal to or greater than the threshold, the apparatus for the convolution operation skips the convolution operation and outputs ‘0’ (S630).

As the determining result of step S620, if the number of ‘0’ is not equal to or greater than the threshold, the apparatus for the convolution operation performs the convolution operation for the corresponding partial region (S640) and outputs the convolution operation result as an input of the activation function (S640). That is, the apparatus for the convolution operation multiplies each value of the corresponding partial region with the corresponding weight of the mask (filter), and then sums each value. Thereafter, the apparatus for the convolution operation outputs the convolution operation result as an input of the activation function. At this time, the activation function may be ReLU, and the apparatus for the convolution operation may output ‘0’ if the input value is less than 0 by the ReLU, and output a value continuously increasing in proportion to the value if not.

The apparatus for the convolution operation stores the value output in step S630 or S640 in the memory unit (S650).

It is understood to those skilled in the art that the present disclosure may be implemented as a modified form without departing from an essential characteristic of the present disclosure. Therefore, the disclosed exemplary embodiments should be considered from not a limitative viewpoint but an explanatory viewpoint. The scope of the present disclosure is described in not the above description but the appended claims, and it should be analyzed that all differences within the scope equivalent thereto are included in the present disclosure.

What is claimed is:

1. An apparatus for a convolution operation of a convolution neural network comprising:
an operation control unit that determines whether or not to perform a convolution operation based on the number of ‘0’ in a partial region of an input feature map; and
an operation unit that performs the convolution operation of the partial region according to the determination of the operation control unit.

2. The apparatus for a convolution operation of a convolution neural network of claim 1, wherein the operation control unit retrieves ‘0’ in the partial region and skips the convolution operation if the number of ‘0’ is equal to or greater than a predetermined threshold to output ‘0’ and provides the partial region to the operation unit when the number of ‘0’ is not equal to or greater than the threshold.

3. The apparatus for a convolution operation of a convolution neural network of claim 1, the apparatus further comprising:
a threshold setting unit that sets a threshold based on at least one of a size of the mask, a stride, and a position of the image.

4. The apparatus for a convolution operation of a convolution neural network of claim 3, wherein the threshold setting unit decreases the threshold to less than a reference threshold when the size of the mask is equal to or greater than a reference size and increases the threshold to the reference threshold or more when the size is not equal to or greater than the reference size.

5. The apparatus for a convolution operation of a convolution neural network of claim 3, wherein the threshold setting unit increases the threshold to a reference threshold or more when the stride is equal to or greater than a reference stride and decreases the threshold to less than the reference threshold when the stride is not equal to or greater than the reference stride.

6. The apparatus for a convolution operation of a convolution neural network of claim 3, wherein the threshold setting unit increases the threshold toward a central portion from an edge of the image.

7. A method for a convolution operation which is performed by an apparatus for the convolution operation, the method comprising:
determining whether or not to perform a convolution operation based on the number of ‘0’ in a partial region of an input feature map; and
performing the convolution operation of the partial region when determining the performing of the convolution operation.

8. The method of claim 7, wherein in the determining the performing of the convolution operation, ‘0’ is retrieved in the partial region and the convolution operation is skipped if the number of ‘0’ retrieved is equal to or greater than a predetermined threshold to output ‘0’.

9. The method of claim 8, wherein the threshold is a value set based on at least one of a size of the mask, a stride, and a position of the image.

10. The method of claim 9, wherein the threshold is less than a reference threshold when the size of the mask is equal to or greater than a reference size and is the reference threshold or more when the size of the mask is not equal to or greater than the reference size.

11. The method of claim 9, wherein the threshold is a reference threshold or more when the stride is equal to or greater than a reference stride and is less than the reference threshold when the stride is not equal to or greater than the reference stride.

12. The method of claim 9, wherein the threshold increases toward a central portion from an edge of the image.
